(19) United States
(12) Patent Application Publication
(10) Pub. No.: US 2011/0206582 A1
(43) Pub. Date: Aug. 25, 2011

(54) GAS SCRUBBING APPARATUS AND GAS SCRUBBING METHOD

(76) Inventors: Ik Nyun Kim, Seoul (KR); Young Yeon Ji, Gyeonggi-do (KR)

(21) Appl. No.: 13/126,385

(22) PCT Filed: Oct. 27, 2009
(86) PCT No.: PCT/KR09/06208

§ 371 Date: Apr. 27, 2011

(30) Foreign Application Priority Data
Oct. 27, 2008 (KR) 10-2008-0105267

(51) Int. Cl. B01D 53/76; B01J 19/08

(52) U.S. Cl. 423/210; 422/186.04

(57) ABSTRACT

Provided are an apparatus for gas scrubbing and a method for gas scrubbing. The apparatus for gas scrubbing includes: a reaction tube through which a reaction gas is flown in; a reactor which is connected to the reaction tube and activates the reaction gas with plasma; and a water injection port which injects water to the plasma in the reactor. It allows a very economical gas scrubbing because water is vaporized using the plasma as heat source, without using an additional heater. In addition, the efficiency of gas scrubbing is also improved because water is directly vaporized at an optimized region where the reaction gas in plasma state is discharged.

### CROSS-REFERENCE TO RELATED APPLICATION

This application claims priority to Korean Patent Application No. 10-2008-0105267, filed on Oct. 27, 2008 and all the benefits accruing therefrom under 35 U.S.C. §119, the contents of which in its entirety are herein incorporated by reference.

### BACKGROUND

1. Field

The present invention relates to an apparatus and a method for gas scrubbing, more particularly to an apparatus and a method for gas scrubbing with improved efficiency over existing ones in that gas scrubbing may be accomplished economically and water is directly vaporized at an optimized region where the reaction gas in plasma state is discharged.

2. Description of the Related Art

In general, semiconductor manufacturing processes involve a variety of chemical reactions and fluorine gases such as NF₃, CF₄, etc., volatile organic compounds (VOCs), or the like are discharged as waste gas. If such a waste gas is discharged into the atmosphere without being purified below a certain level, severe air and environmental pollution may be brought about. Therefore, a gas scrubber is used to clean the waste gas.

The existing gas scrubbers include a wet type gas scrubber which removes water soluble noxious gases by dissolving them in water, a burning type gas scrubber which removes combustible gases by burning them, a method of directly oxidizing waste gas using a heater and spraying water to the oxidized gas to separate powder included in the oxidized gas, an adsorption/catalysis type of removing noxious gas using an adsorbent by means of van der Waals attraction, and so on. Among them, the wet type scrubber is commonly used because it is more effective than other types and is superior in process economics.

FIG. 1 schematically shows a wet type gas scrubber used in an existing gas scrubbing apparatus for semiconductor process.

Referring to FIG. 1, a gas scrubber 1 consists of a wet chamber 10 at an upper portion and a water circulation tank 20 at a lower portion. A gas inlet 11 is equipped on the wet chamber 10, and a gas outlet 12 is equipped on a side surface thereof. Further, a partition wall 13 separating the inside of the wet chamber 10 is installed along an axial direction. Near the lower portion of the partition wall 13, an absorbent 16 which filters water-soluble gas is installed. A water supply tube 14 equipped with a nozzle 15 for spraying water to the absorbent 16 penetrates the wet chamber 10 from a side surface thereof. And, at a side surface of the water circulation tank 20, a water outlet 22 through which the water that has been supplied to the wet chamber 10 is discharged outward after circulation is installed.

The gas scrubber 1 works as follows. Water-soluble gas is contacted with water while it slowly passes through the absorbent 16 to which water is sprayed at an intermediate portion of the wet chamber 1C). However, such a wet type gas scrubber is problematic in that a large amount of water is consumed, reaction does not proceed efficiently because of large molecular size of water, and frequent maintenance is required due to the blocking of the nozzle.

Thus, there have been attempts to improve the efficiency of scrubbing by reducing the molecular size of water. As an example, Korean Patent No. 10-0501533 discloses a gas scrubber which consumes less water wherein water is vaporized so that the resultant water with reduced molecular size reacts easily with gas. However, because it requires an additional heater or ultrasonic apparatus, it is disadvantageous in economics and apparatus size.

### SUMMARY

Accordingly, a first object of the present invention is to provide an apparatus for gas scrubbing which is economical and enables effective apparatus setup.

A second object of the present invention is to provide an effective method for gas scrubbing using the apparatus for gas scrubbing.

In an aspect to accomplish the first object, the present invention provides an apparatus for gas scrubbing, including: a reaction tube through which a reaction gas is flown in; a reactor which is connected to the reaction tube and activates the reaction gas with plasma; and a water injection port which injects water to the plasma in the reactor. In an embodiment of the present invention, the water injection port may be in the form of a dropper which drops water droplets at a constant rate, and may be spaced apart from the reaction tube by 10 to 20 cm. Water injection rate may be 2 to 10 mL/min.

In another aspect to accomplish the first object, the present invention provides an apparatus for gas scrubbing, including: a reaction tube through which a reaction gas is flown in; a reactor which is connected to the reaction tube and activates the reaction gas with plasma; and a nozzle which directly injects water into the reactor by an external pressure, wherein the water injected into the reactor through the nozzle is vaporized by the plasma as a heat source, so that it reacts with the reaction gas plasma. The nozzle may be spaced apart from the reaction tube by 10 to 20 cm.

In another aspect to accomplish the first object, the present invention provides an apparatus for gas scrubbing, including: a reaction tube through which a reaction gas is flown in; a reactor which is connected to the reaction tube and activates the reaction gas with plasma; a pipeline which is in contact with the reactor and is filled with water; and a nozzle which injects the water in the pipeline vaporized by the heat of the reactor into the reactor. The nozzle may be spaced apart from the reaction tube by 10 to 20 cm. And, the pipeline may be located inside the wall of the reactor, so that the reactor may have a double wall.

In an aspect to accomplish the second object, the present invention provides a method for gas scrubbing, including: flowing in a reaction gas; activating the reaction gas with plasma; and injecting water vaporized using the reaction gas plasma as a heat source to the reaction gas plasma, so that it reacts with the reaction gas plasma. The water may be vaporized at a location spaced apart from a flame starting point of the reaction gas plasma by 10 to 20 cm to provide the best effect.

The gas scrubbing apparatus according to the present invention enables very economical gas scrubbing because water is vaporized the plasma as a heat source, without using an additional heater. In addition, the efficiency of gas scrubbing is also improved because the reaction gas is scrubbed by directly vaporizing water at an optimized region where the reaction gas plasma is discharged.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 schematically shows a wet type gas scrubber used in an existing gas scrubbing apparatus for semiconductor process;

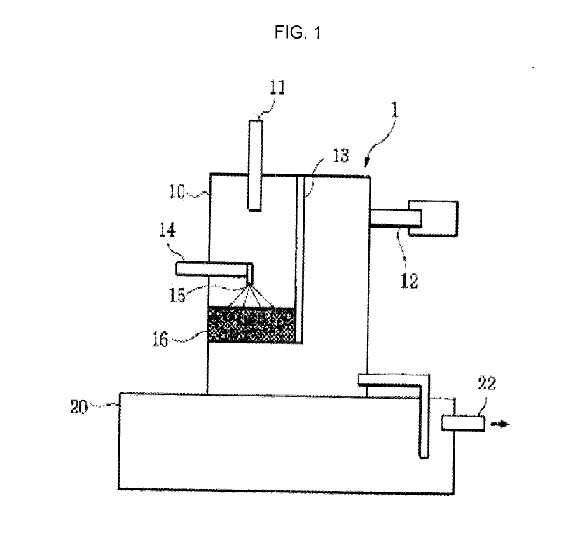

FIG. 2 schematically shows an apparatus for gas scrubbing according to an embodiment of the present invention;

FIG. 3 schematically shows water injection according to the present invention;

FIG. 4 schematically shows an apparatus for gas scrubbing according to another embodiment of the present invention; and

FIG. 5 schematically shows an apparatus for gas scrubbing according to another embodiment of the present invention.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

According to the present invention, plasma is employed to decompose a reaction gas and to vaporize water, as described above. In particular, because these processes occur in the same reactor, the vaporized water may immediately react with the reaction gas in plasma state, thereby enabling very fast removal of the reaction gas.

The term “reaction gas” used in this specification refers to a gas which is decomposed by plasma to be removed, and includes perfluorinated compounds (PFCs), volatile organic compounds (VOCs), etc. exhausted from the semiconductor process or the like. However, the scope of the present invention is not limited to the semiconductor process. Any gas that may be decomposed by plasma and scrubbed by water vapor falls within the scope of the present invention.

Particularly, when PFCs generated from the semiconductor process are decomposed by plasma, various radical species are formed. According to the present invention, the radicals may be easily removed by reacting with water. Conventionally, an additional heater was used to vaporize water to increase the reaction area of water. However, according to the present invention, heater or other additional apparatus is unnecessary because water is vaporized immediately after it is injected into the reactor by the heat of the plasma. Further, whereas the existing technique requires a process of injecting the vapor produced from the separate apparatus to the waste gas, the present invention does not need such a process because water vapor is produced in the reactor where the activated reaction gas is present and reacted with the reaction gas. As a result, the problem of condensation of the water vapor during transport is avoided. In addition, whereas the existing technique requires an additional apparatus such as heating coil to prevent such condensation, the present invention does not need it and, thus, is very economical.

The term “reactor” used herein refers to a space where the reaction gas is activated by plasma and the reaction gas activated by plasma reacts with vaporized water physically or chemically. The reactor may be in the form of a tube or vessel. However, the type of the reactor is not particularly limited, as long as water may be vaporized by plasma in the reactor and the vaporized water may react with the reaction gas activated by the plasma.

Hereinafter, the present invention will be described in more detail referring to the appended drawings.

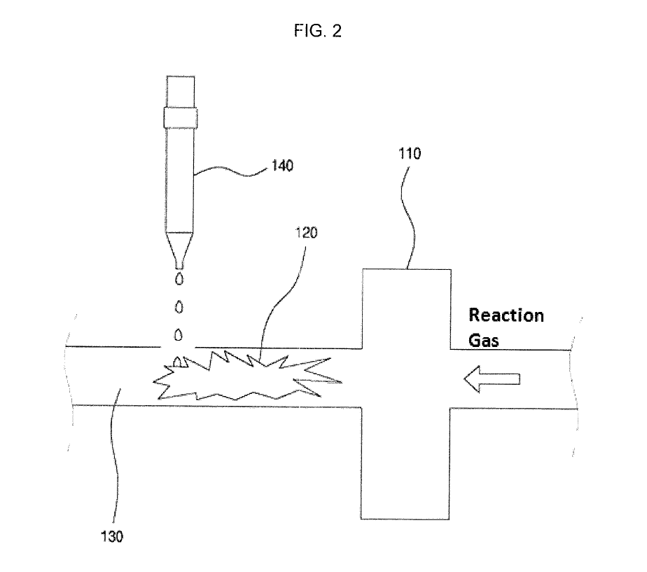

FIG. 2 schematically shows an apparatus for gas scrubbing according to an embodiment of the present invention.

Referring to FIG. 2, a reaction gas that should be discharged into the atmosphere, i.e. that should be scrubbed, is flown into a reaction tube 110. Then, a torch reaction to activate the reaction gas with plasma occurs in the reaction tube 110. The reaction tube may be in any form capable of igniting the reaction gas. In an embodiment of the present invention, the plasma process may be carried out using microwave plasma. However, any type of plasma may be used as long as it can activate the reaction gas with plasma and accomplish a temperature capable of vaporizing water.

The reaction gas ignited in the reaction tube is then discharged to a reactor 130 which is connected to the reaction tube 110. In an embodiment of the present invention, the reactor 130 may be in a tube form. Alternatively, the reactor 130 may be in a vessel form as will be described in another embodiment.

In the reactor, a plasma flame 120 extends a distance L from the reactor. Inside the reactor 130, the reaction gas is turned into activated species by the plasma. As described above, when water is injected to the plasma 120 where the activated reaction gas exists, the water is vaporized in the reactor 130 by the heat of the plasma 120 and the vaporized water effectively reacts with the activated reaction gas. Accordingly, the apparatus for gas scrubbing according to the present invention is equipped with a water injection port 140 for injecting water to the reactor 130. The water injection port 140 may be in the form of a nozzle which sprays minute water molecules or a dropper which drops water droplets at a constant rate at a specific portion. In case a dropper is used, the injection rate of water may be preferably 2 to 10 mL/min. At a lower injection rate, scrubbing effect may be insignificant. And, at a higher injection rate, plasma discharge may become extinct or reaction with water may not occur.

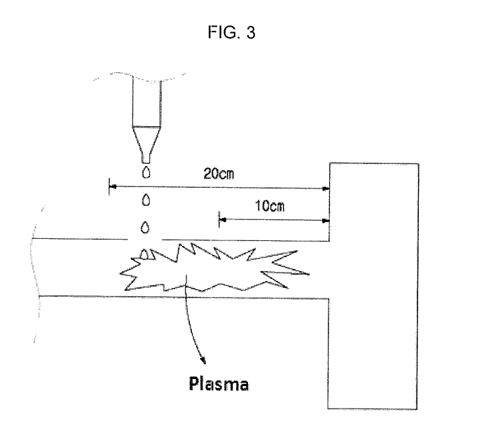

The inventors of the present invention have found that the activated reaction gas reacts very efficiently with water vapor when water is injected at a specific portion in the reactor 130, preferably at 10 to 20 cm, more preferably at 18 cm, from the reaction tube 110. The technical significance of the numerical range will be described in detail later referring to FIG. 3.

FIG. 3 schematically shows water injection according to the present invention.

Referring to FIG. 3, if water is injected too close from the reaction tube 110, i.e. within 10 cm from the reaction tube, reaction between vaporized water and the reaction gas may be insufficient because the reaction gas is not sufficiently activated there. On the contrary, if water is injected farther than 20 cm, water may not be sufficiently vaporized. Accordingly, in case a water injection port in the form of a nozzle is used, it is preferred to configure such that water is sprayed by the nozzle within the aforesaid range (For instance, the nozzle may be installed within the range and it may be configured such that water sprayed from the nozzle may fall within the range.). And, in case a dropper type water injection port is used, it may be configured such that water droplets may be dropped within the range. More than one nozzle or dropper may be equipped to induce reaction at a larger area.

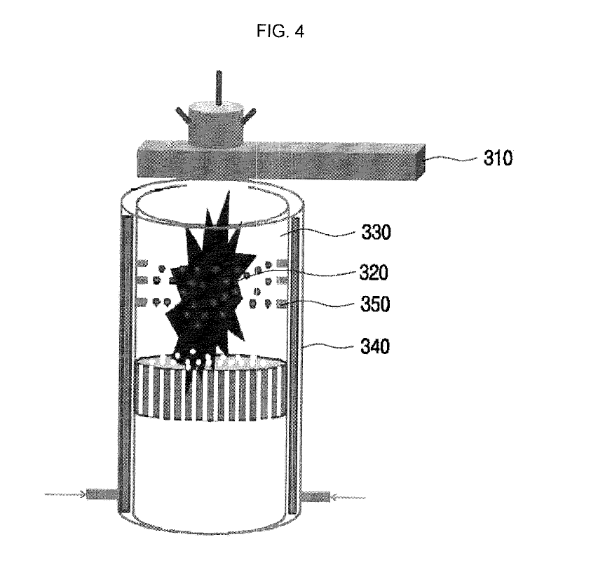

FIG. 4 schematically shows an apparatus for gas scrubbing according to another embodiment of the present invention.

Referring to FIG. 4, in this embodiment, a reactor 330 is in the form of a cylindrical vessel and water is filled in a pipeline 340 which contacts the outer surface of the reactor 330.

As in the aforedescribed embodiment, as a reaction gas is activated by plasma in a reaction tube 310, the temperature inside the reactor 330 is increased by plasma 320. Then, water in the pipeline 340 is heated and vaporized. The pressure inside the pipeline 340 rises slowly as water is vaporized, and the vaporized water is injected through a nozzle 350 into the reactor 330. In another embodiment of the present invention, the pipeline may be equipped inside the wall of the reactor. In this case, the reactor has a double wall structure. That is to say, water is flown in through inside the double wall of the reactor. As the reactor temperature increases due to plasma generation, water in the double wall is vaporized and injected into the reactor. The vaporized water reacts with the reaction gas in plasma state and removes harmful components from the exhaust gas. Such a configuration allows vaporization and injection of water using the plasma as heat source without having to apply pressure. Accordingly, it is more economical than the existing technique because a spraying process using an additional ejector, ultrasonicator, etc. is not necessary. In addition, since the water remaining after the completion of the plasma process can be used to scrub HF in the reactor, no additional wet scrubbing of the reactor is required.

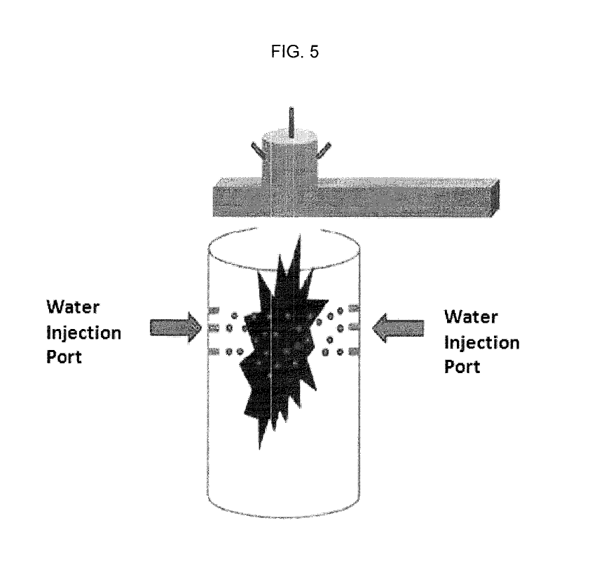

FIG. 5 schematically shows an apparatus for gas scrubbing according to another embodiment of the present invention which is slightly different from that of FIG. 4. Referring to FIG. 5, water is injected directly into a reactor by an external pressure, instead of contacting water with the reactor and vaporizing it using the heat of the reactor. Also in this case, wet scrubbing may be accomplished with superior scrubbing effect in real time without using an additional heater.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. An apparatus for gas scrubbing comprising:
a reaction tube through which a reaction gas is flown in;
a reactor which is connected to the reaction tube and activates the reaction gas with plasma; and
a water injection port which injects water to the plasma in the reactor.

2. The apparatus for gas scrubbing according to claim 1, wherein the water injection port is in the form of a dropper which drops water droplets at a constant rate.

3. The apparatus for gas scrubbing according to claim 1, wherein the water injection port is spaced apart from the reaction tube by 10 to 20 cm.

4. The apparatus for gas scrubbing according to claim 1, wherein the water injection port injects water at a rate of 2 to 10 mL/min.

5. An apparatus for gas scrubbing comprising:
a reaction tube through which a reaction gas is flown in;
a reactor which is connected to the reaction tube and activates the reaction gas with plasma; and
a nozzle which directly injects water into the reactor by an external pressure,
wherein the water injected into the reactor through the nozzle is vaporized by the plasma a heat source, so that it reacts with the reaction gas plasma.

6. The apparatus for gas scrubbing according to claim 5, wherein the nozzle is spaced apart from the reaction tube by 10 to 20 cm.

7. An apparatus for gas scrubbing comprising:
a reaction tube through which a reaction gas is flown in;
a reactor which is connected to the reaction tube and activates the reaction gas with plasma;
a pipeline which is in contact with the reactor and is filled with water; and
a nozzle which injects the water in the pipeline vaporized by the heat of the reactor into the reactor.

8. The apparatus for gas scrubbing according to claim 7, wherein the pipeline is located inside a wall of the reactor, so that the reactor has a double wall.

9. The apparatus for gas scrubbing according to claim 7, wherein the nozzle is spaced apart from the reaction tube by 10 to 20 cm.

10. A method for gas scrubbing comprising:
flowing in a reaction gas;
activating the reaction gas with plasma; and
injecting water vaporized using the reaction gas plasma as a heat source to the reaction gas plasma, so that it reacts with the reaction gas plasma.

11. The method for gas scrubbing according to claim 10, wherein the water is vaporized at a location spaced apart from a flame starting point of the reaction gas plasma by 10 to 20 cm.
